(19) United States
(12) Patent Application Publication
(10) Pub. No.: US 2011/0143705 A1
(43) Pub. Date: Jun. 16, 2011

(54) Medical information retrieval

(76) Inventors: Mark Ellery Ogram, Tucson, AZ (US); Wayne Rod, Tucson, AZ (US)

(21) Appl. No.: 12/932,028

(22) Filed: Feb. 15, 2011

Related U.S. Application Data
(63) Continuation of application No. 12/070,701, filed on Feb. 19, 2008.
Application No. 12/070,701 is a continuation-in-part of application No. 12/012,402, filed on Feb. 1, 2008.

(51) Int. Cl. H04W 4/22; H04W 88/02

(52) U.S. Cl. 455/404.1; 455/550.1; 455/566

(57) ABSTRACT

The invention is an apparatus and a system designed to communicate critical medical information to an emergency care-giver such as a paramedic. Using a cellular telephone, the user creates the medical information that they deem appropriate (i.e. medications being taken, doctor with phone number, and medical conditions). This medical information is stored either locally on the cellular telephone or on a remote computer. The emergency care-giver is able to easily access this information by pressing a single button to get the medical information displayed on the screen on the cellular telephone or audibly recreated on the cellular telephone.

This is a continuation of U.S. patent application Ser. No. 12/070,701, filed on Feb. 19, 2008, and entitled “Medical Information Retrieval”, which was a continuation-in-part of U.S. patent application Ser. No. 12/012,402 entitled “Emergency Call from a Cell Phone” filed Feb. 1, 2008.

### BACKGROUND OF THE INVENTION

This invention relates generally to the storage and retrieval of information and more specifically to the storage and retrieval of medical information.

Cell phones have become ubiquitous in modern society. They allow the user to contact others with voice information, to receive information, and to gather information (i.e. maps) for the user. In fact, it is now uncommon for someone to be without a cell phone.

The empowerment that the cell phone gives, and the security or protection that user is able to derive from it, allows people to venture into new areas with the assurance that “help” is only a phone call away. Using “9-1-1” a caller is able to contact emergency personnel to request a variety of emergency assistance.

The same sort of voice controlled, and even automatic assistance, is available through a variety of service providers such as “ON-STAR”. These types of service providers allow a manual activation (and also automatic activation) which reports the vehicle's position (as obtained from the Global Positioning System (“GPS”) to the service provider so that emergency personnel can be notified.

GPS is not unique to these type of service providers. Rather, GPS and the associated mapping capability, is found in a variety of devices including cell phones. Such a system is described in U.S. Pat. No. 7,312,700, entitled “GPS Enabled Cell Phone with Common Interest Alerts” issued to Karaguz et al. on Dec. 25, 2007, incorporated hereinto by reference.

It is clear that the cell phone has a variety of applications and continues to become an ever more useful tools for society.

### SUMMARY OF THE INVENTION

The invention provides a portable communications apparatus which is useful for reporting positional status response to user selected recipient(s). While the present invention contemplates its use with a service provider, such as an emergency assistance facilitator, the invention's more prominent role is to empower the user by allowing the user to define who is to receive the message. Even the message itself is defined by the user.

The user-defined message, when it is sent, contains not only the message, but the location information as well.

Using a positioning receiver, such as GPS, the apparatus is able to automatically identify its own location. This information, usually in latitude and longitude coordinates or another type of location identifier, provides the recipient with expanded and useful information. Those of ordinary skill in the art readily recognize a variety of implementations of GPS into cell phones, including, but not limited to: U.S. Pat. No. 7,312,712, entitled “Traveler Safety Notification System” issued to Worrall on Dec. 25, 2007; and, U.S. Pat. No. 7,312,697, entitled “Method of Using Telematic Units to Place Courtesy Notifications” issued to Veliu et al., both of which are incorporated hereinto by reference.

The latitude/longitude of the GPS is readily transformed into maps and actual addresses through a variety of techniques well known to those of ordinary skill in the art.

In practice, for the preferred embodiment of the invention, the user establishes the message which they want sent. Such a message may denote an emergency, such as:
“Dad, had car trouble. Please come. I'm at . . . ”
   or may be a simple status message, such as:
“Getting closer to your house, now at . . . ”

The user is then able to denote where these messages will be sent. In the emergency message above, the recipient would be the father's e-mail address and instant message address. In the status message above, the message might be the instant message address for the individual who is at the final destination.

In either case, it is the user of the portable apparatus or cell phone, who defines who is to receive the message.

In some embodiments of the invention, there may be a pre-defined recipient for the emergency message such as a service provider for emergency services.

These messages remain inactive and stored in the memory of the cell phone or portable apparatus until activated by the user. Often these message is stored in memory (such as Random Access Memory, “RAM”) for an hour or more before being called into use.

Activation is ideally through the “pressing” of a single button. This encourages the use of the messaging system without placing any real operating burden on the user.

In another version, the message system is activated when an emergency phone call (i.e. 9-1-1) is activated. This provides backup and notification to the designated receiver. As example, when the user dials 9-1-1, not only are they connected to the appropriate emergency facility, but, a message such as the following may be sent:
“Emergency call sent out by your daughter from 5678 Oak Drive”

The system lies dormant until the user activates it. When activated by the user, the system combines the user-defined message with the location information (sometimes with the GPS coordinates), and sends the completed message to the user-defined recipient. In this manner, the user of the apparatus is in total control of: the message's content; when the message is sent; and who receives the message.

Communication of the completed message is using any of a variety of techniques well known to those of ordinary skill in the art. Examples of such communications mechanisms are described in U.S. Pat. No. 7,308,247, entitled “Cellular Telephone Safety System” issued to Thompson et al. on Dec. 11, 2007; and, U.S. Pat. No. 7,315,747, entitled “Handheld Electronic Device and Associated Method Providing Availability Data in a Messaging Environment” issued to Klassen et al. on Jan. 1, 2008, both of which are incorporated hereinto by reference.

In some embodiments of the invention, the message is expanded to include a map showing the location of the apparatus (based upon the GPS information) or an approximate address of the location. Using the example of the contact message above, the resulting message may then become:
“Dad, had car trouble. Please come. I'm at 1234 Main Street, Tucson, Ariz.”

In the case where a simple status message is appropriate, then the completed message could be:
“On our way to California, we are now at 124 Main Street, Tucson, Ariz. (Latitude/Longitude)”

This capability allows the cell phones (or other portable device) to communicate a completed message at the pressing of a single button.

In a further embodiment of the invention, an apparatus and a system is established to communicate critical medical information to an emergency care-giver such as a paramedic. This embodiment of the invention provides a highly portable medical record that can be accessed easily by the user/patient (i.e. for retrieval of a prescription list) or by the paramedic (i.e. obtaining vital medical information assisting in emergency treatment).

Using a cellular telephone, the user creates the medical information that they deem appropriate (i.e. medications being taken, doctor with phone number, and medical conditions). Note, it is the user that provides this information. In the case of an elderly or incapacitated individual, the information may be entered into the apparatus by a care-giver.

This medical information is stored either locally on the cellular telephone or on a remote computer. The medical information is ideally stored in an archive type of memory, well known to those of ordinary skill in the art.

In this manner, the information is created and stored for a later retrieval, ideally at some future point at least a week in advance. In this manner, the user creates any information that they feel that would be important in case of an emergency.

As example, a diabetic user might enter the following:
“My name is John Smith, I am a diabetic and am taking 5 g of insulin a day. My doctor's name is Dr. Jane Dough and can be reached at, 555-123-4567”

Once the information is stored, the user does not need to edit it as it is stored within an archive memory.

In some embodiments, the archive memory is located within the cellular telephone itself; in other embodiments, a remote computer has the archive memory and stands ready with the information in an emergency situation.

In use, the emergency medical technician is able to easily access this information by pressing a single button (“retrieval key”) located on the cellular phone or on the cellular phone's menu. The emergency medical technician (EMT) simply activates the retrieval key on the cellular telephone and the information is retrieved from the archive memory and communicated to the EMT. The medical information often is critical during the emergency in identifying what may/may not be the cause of the medical emergency and how to properly respond to the patient's own medical conditions.

The medical information from the archive memory is optionally displayed on a screen on the cellular telephone or is audibly replayed by the cellular telephone.

The invention, together with various embodiments thereof, will be more fully explained by the following descriptions of the attached drawings.

### DRAWINGS IN SUMMARY

FIGS. 1A and 1B are transparent views and covered views of the preferred portable communications apparatus of this invention.

FIG. 2 graphically illustrates the components of the system of which the portable communications apparatus interacts.

FIGS. 3A and 3B is a flowchart and message structure for the creation of the stored message string within the portable communications apparatus.

FIG. 4 is a flowchart of the operation of the preferred messaging system for the portable communications apparatus.

FIG. 5 is a flowchart of the operation of the receiver/transmitter of the preferred embodiment.

FIGS. 6A and 6B illustrate alternative embodiments of the medical record apparatus of the current invention.

FIG. 7 is a flowchart illustrating the entry of the medical information by the user.

FIG. 8 is a flowchart illustrating the preferred embodiment's operation which has the archive memory contained within the cellular telephone.

FIGS. 9A and 9B are flowcharts of the preferred operation of the cellular telephone and the remote computer's operation where the archive memory is located at the remote computer.

### DRAWINGS IN DETAIL

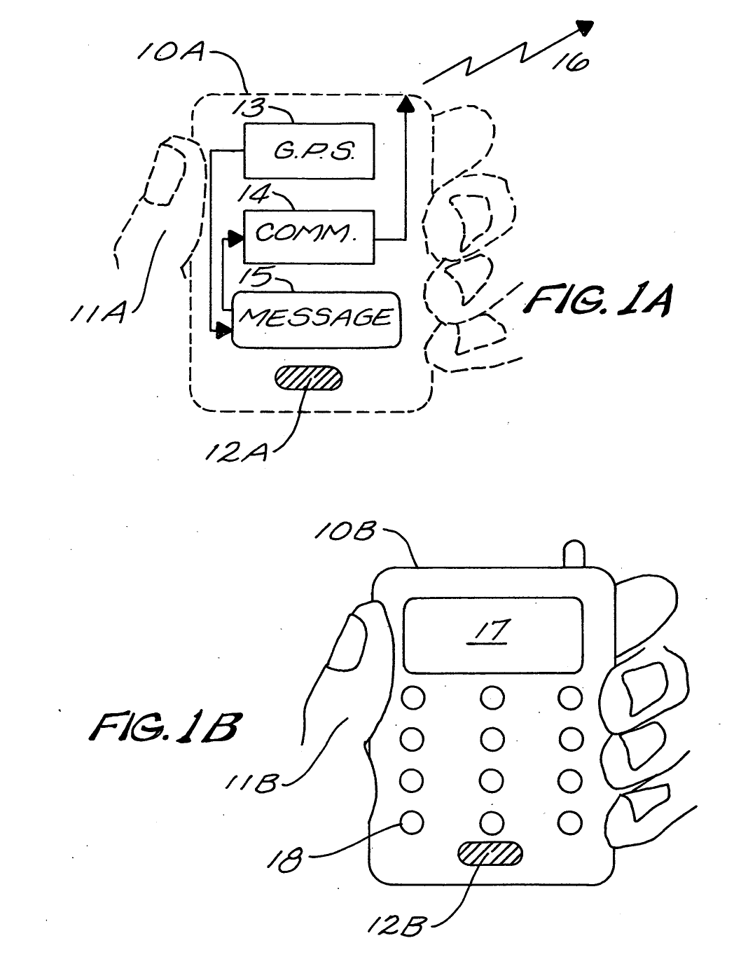

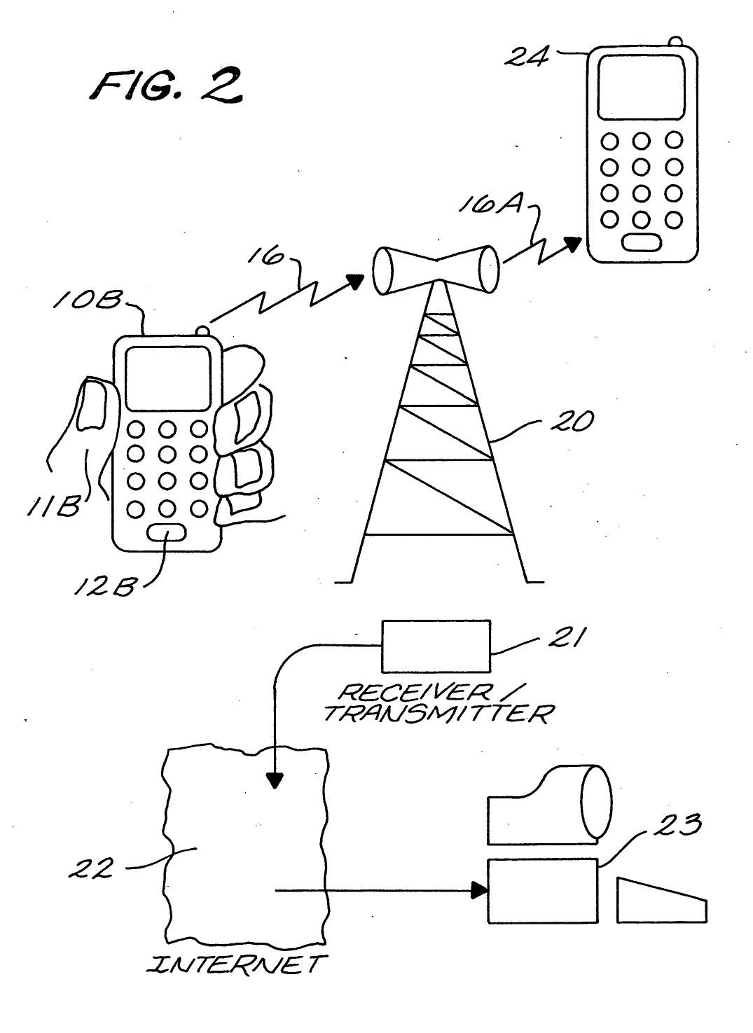

FIGS. 1A and 1B are transparent views and covered views of the preferred portable communications apparatus of this invention.

Referring to FIG. 1A, the transparent view of the preferred portable communications apparatus, operator 11A holds the communications apparatus 10A in his hand. Communications apparatus 10A is any of many different devices well known to those of ordinary skill in the art and include such items as cellular phones, walkie talkies, and palm held computers.

Within communications apparatus 10A is a GPS receiver 13 which uses satellite generated positional signals to generate indicia of the latitude and longitude of the position of the communications apparatus 10A.

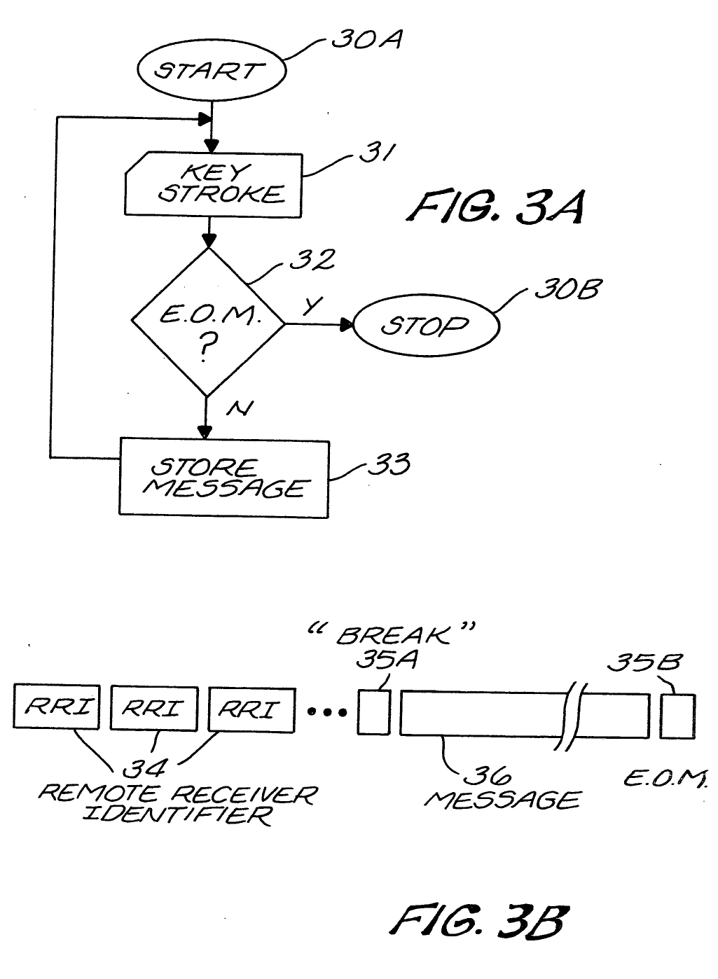

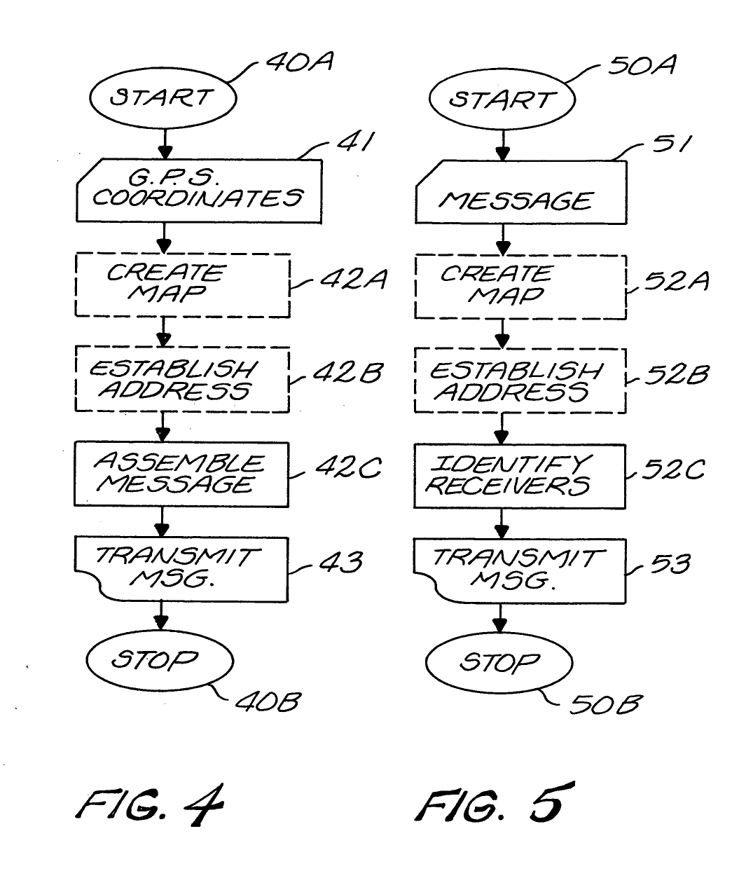

The message system 15 has stored therein the user-defined message together with at least one user-defined remote receiver identifier. Creation of the user-defined message and the remote receiver identifiers is made by operator 11A which is described in more detail relative to FIGS. 3A and 3B.

When operator 11A activates the message system 15 via message button 12A, message system 15 obtains the indicia from the GPS receiver 13, incorporates this indicia (or representation thereof) into the user-defined message, and sends the completed message, together with the user-defined remote receiver identifiers, to the communications mechanism 14.

The communications mechanism 14 communicates the completed message to the locations associated with the user-defined remote receiver identifiers via radio transmission 16.

Now referring to FIG. 1B, operator 11B holds the communications apparatus 10B which includes keyboard 18, screen 17, and message button 12B.

Screen 17 is used for operator prompt, to display the user-defined message (while it is being created and for editing purposes), and to display the user-defined remote receiver identifiers.

In this illustration, keyboard 18 is a simple numeric keypad, but, in the preferred embodiment of the invention, a “QWERTY” keyboard is provided to facilitate operator entry of data.

FIG. 2 graphically illustrates the components of the system of which the portable communications apparatus interacts.

Operator 11B, as described above, has created a message and destination within the memory of communications apparatus 10B. Later, when operator 11B activates the messaging system via button 12B, the message and location are sent to the designated destinations via radio waves 16.

Receiver/Transmitter 20 receives radio waves 16 and identifies the destinations associated with the message/GPS coordinates. In one situation, the message/GPS coordinates are sent by receiver/transmitter 20 via radio waves 16A to another communications apparatus 24. As in the above example, this communications apparatus 24 will receive the message:
“Dad, had car trouble. Please come. I'm at 1234 Main Street, Tucson, Ariz.”
   and be able to respond accordingly.

In this illustration, the destinations associated with the message/location received by receiver/transmitter 20 include an e-mail address for computer 23. In this instance, the message/GPS coordinates are sent from computer 21 connected to the receiver/transmitter 20, via Internet 22 to computer 23.

Computer 23 may also be associated with a friend or family of operator 11B; but, in some situations, computer 23 also includes service providers such as an automobile servicing agency, or an emergency provider.

In the case of the emergency provider such as a fire department, operator 11B may be an off-duty fireman who wants to instantly report a fire, in this case, the message/location could read:
“Smoke or Fire has been seen at 1234 Main Street, Tucson, Ariz.”

Some embodiments of the invention provide mapping functions which optionally include driving instructions from computer 23 to the location of communications apparatus 10B. In some embodiments, this map generating function is accomplished at communications apparatus 10B and is included in the message; in other embodiments, computer 21 performs this function.

FIGS. 3A and 3B is a flowchart and message structure for the creation of the stored message string within the portable communications apparatus.

In creating the data for memory, in this embodiment, as shown in FIG. 3A, once the program has started 30A, the key stroke into the communications apparatus is accepted 31. A determination is then made on if the key stroke is an End Of Message 32; if it is, then the program stops 30B.

If the key stroke is not an End Of Message (“EOM”) 32, then the keystroke is stored in the message. In this manner, the operator, whether using a numeric pad or a QWERTY keypad, is able to create the stored message and destinations.

This embodiment uses the structure within memory as indicated by FIG. 3B for the message and destinations. The string of characters has as a first grouping the Remote Receiver Identifiers 34 which can be of any length or number as defined by the user. A “break” 35A denotes the end of the Remote Receiver Identifiers 34 and the beginning of the message 36.

The length of the message, and its content, is defined by the user and is terminated by an End Of Message 35B.

In this manner, the user is able to store the core message together with the destinations for the message prior to ever having to use it. The time period before the message's storage and its use can vary from tens of minutes to days. As example, a care-giver for an elderly person could establish the following message on their phone which could be activated if the elderly person “wanders off”:
“Mr. John Smith has been located at 9980 Elm Street.”

In this scenario, the user who establishes the message is the care-giver, and the user who activates the message is the person who “finds” Mr. Smith wandering the streets. In this manner, the authorities (i.e. Police), upon finding a confused Mr. Smith on the street is able to alert the care-giver to come and help with him.

FIG. 4 is a flowchart of the operation of the preferred messaging system for the portable communications apparatus.

Once the activation button has been initiated for the message to be sent to the proper destinations, the program starts 40A and obtains the proper GPS coordinates 41. In some embodiments, these GPS coordinates are used to create a map 42A and/or to establish the approximate address 42B where the portable communications apparatus is located.

The message is the obtained from memory and assembled with the location or the map, or the address (depending on the user's choice).

The completed message is then transmitted to the identified destinations 43 and the program stops 40B.

In this manner, the user is not required to do anything other than press the single activation button; the message and location is sent out automatically.

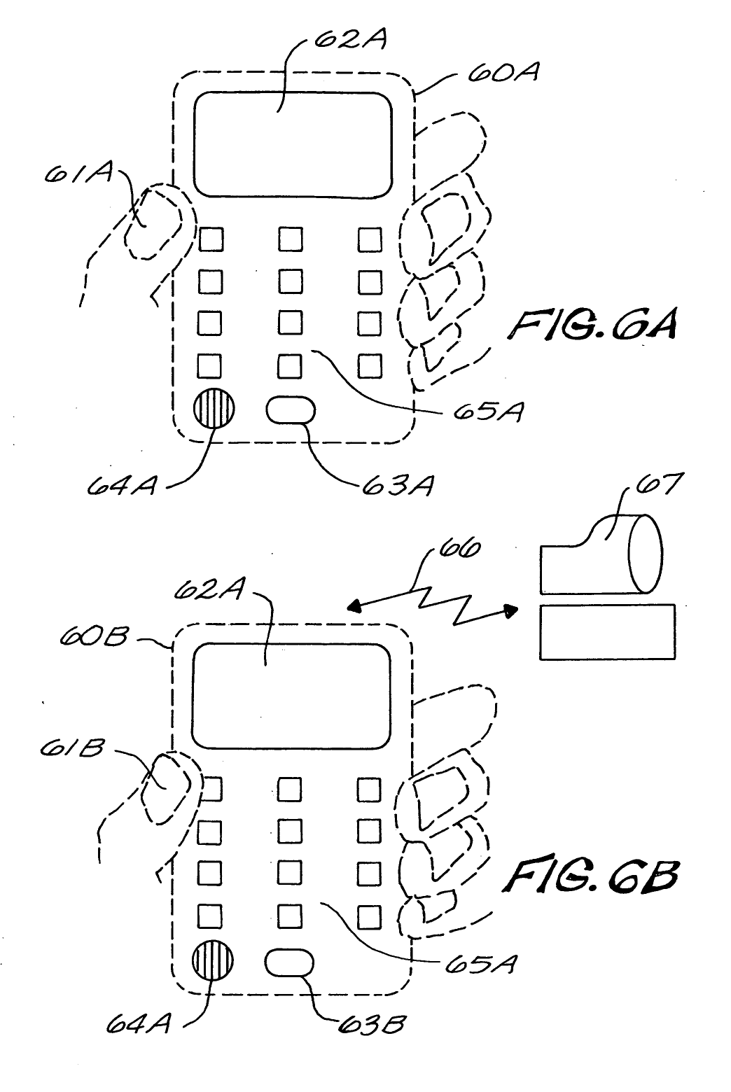

FIG. 5 is a flowchart of the operation of the receiver/transmitter of the preferred embodiment.

The program starts 50A and receives the message and location from the portable communications apparatus. In some embodiments, the location within the message includes the GPS coordinates which are then used to create a map 52A and/or an approximate address 52C, which are combined with the message.

The destinations for the message or receivers are identified 52C and the completed message is transmitted 53 to these designated receivers. The program then stops 50B.

FIGS. 6A and 6B illustrate alternative embodiments of the medical record apparatus of the current invention.

The embodiment of FIG. 6A illustrates the handheld apparatus 60A which is a cellular telephone in this illustration. User 61A is able to view information via screen 62A and to input textual information via keyboard 65A.

User 61A is able to enter text via keyboard 65A and see what the content is via screen 62A. By then entering a “storage” instruction, the text is stored into an archival memory with apparatus 60A where it is stored for an extended period of time ideally in excess of one week.

An emergency technician, when treating g on user 61A, at an accident or medical emergency scene, is able to use apparatus 60A to obtain the text from archival memory by depressing key 63A and have it displayed via screen 62A. This information assists the emergency technician in administering to user 61A.

Optionally, user 61A is able to enter the salient information orally via a microphone and have it stored in the archival memory until such time that the emergency technician activates button 63A to have the information audibly replayed by speaker 64A.

FIG. 6B illustrates another embodiment in which user 61B holds apparatus 60B and enters the health related information via keypad 65A while viewing the content via screen 62A. In this embodiment, the information is stored on a remote computer 67 with the information being communicated via radio waves 66 (either via the Internet or by traditional cellular telephone systems).

In this embodiment, the emergency technician depresses key 63B, thereby engaging apparatus 60B which connects with remote computer 67 to retrieve and display the information via screen 62A of audibly via speaker 64A.

This embodiment is particularly powerful in that in some embodiments, the emergency technician must also enter their own personal access code before the delicate health information is communicated. This provides a level of protection for the sensitive medical information.

Remote computer 67, checks the personal access code against an authorized data base to make sure the party requesting the information is authorized to receive it. This assures user 61B that their health information is maintained as proprietary. The data base contains the identification of all emergency personnel or facilities that should be able to obtain the medical information in the case of an emergency.

In yet another embodiment, the medical information is stored into remote computer 67 by an operator of remote computer 67. In this embodiment, the salient information is communicated to the remote computer's operator via e-mail, mail, or other printed material.

In still another embodiment of the invention, operator 61 sends a message (such as an e-mail or “Instant Message”) to remote computer 67 containing the medical information that operator 61 wants. Remote computer 67 stored the messages in its archival memory. When an emergency technician opens the address portion of apparatus 60B, (such as a cellular telephone), the listing within the address includes a title such as “Med Info” or “Emergency”. When the emergency technician activates this “Emergency” address, the remote computer 67 responds by sending the original message (containing the medical information) back to apparatus 60B. In this manner, the emergency technician is able to obtain the medical information that user 61B so desires.

In another enhancement of this embodiment, when the medical technician engages the “emergency” address, remote computer also sends out messages to destinations previously identified by user 61B. As example, when the emergency information is activated, messages such as the following may go out to the spouse and/or doctor of user 61B:
“The Emergency medical information for John Smith has been access by his cellular telephone number 555-123-4567”

This attribute allows the receivers of this message to call apparatus 60B and get in contact with the emergency technician.

FIG. 7 is a flowchart illustrating the entry of the medical information by the user.

Once the program starts 70A, the keystroke is accepted 71. If the keystroke received indicates an end of the text 72, then the textual information is stored in memory 73A and the program stops 70B; otherwise, the keystroke is added to the text information 73B and the program continues to accept the next keystroke 71.

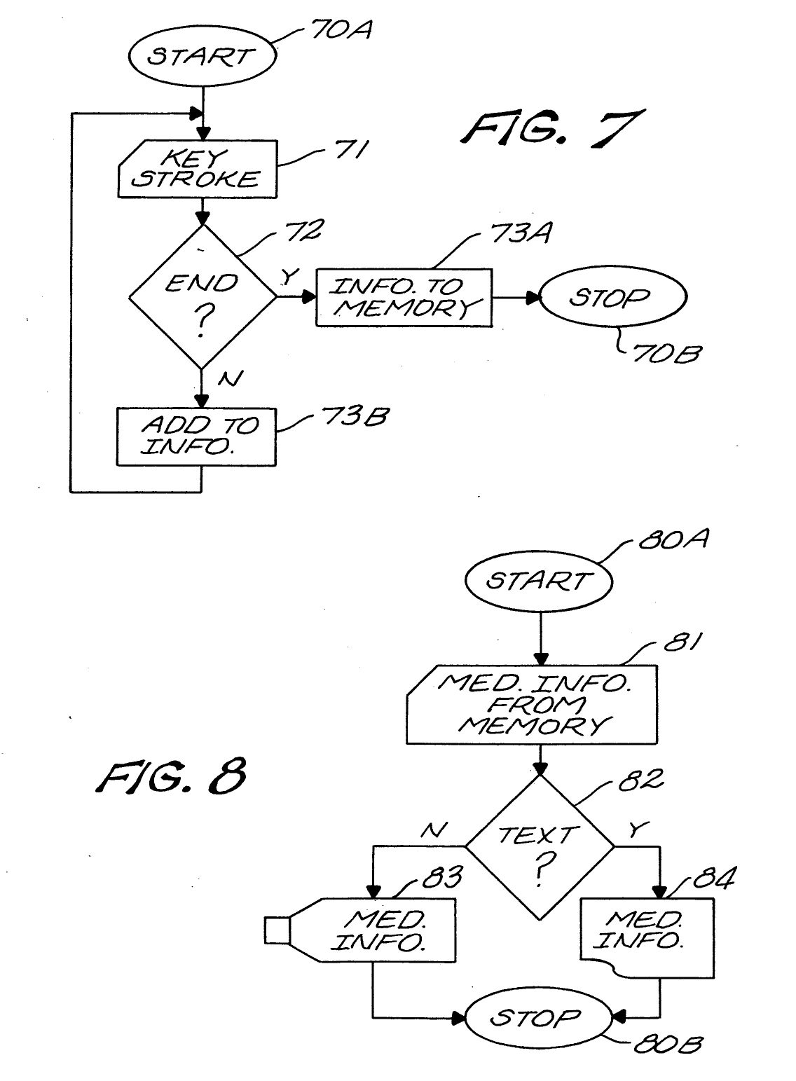

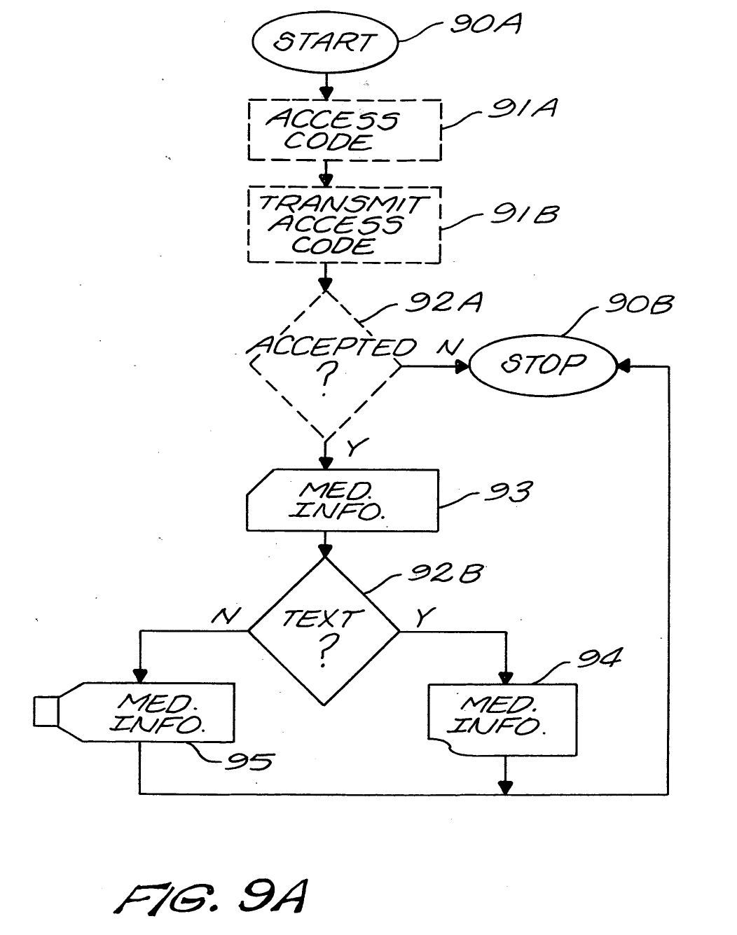

FIG. 8 is a flowchart illustrating the preferred embodiment's operation which has the archive memory contained within the cellular telephone.

Up activation of the retrieval key, the program starts 80A and the medical information is obtained from memory 81. The retrieved medical information may be text 82, in which case the medical information is displayed 84 and the program stops 80B. If the medical information is not textual 82, then the medical information is audible and the medical information is audibly communicated 83 before the program stops 80B.

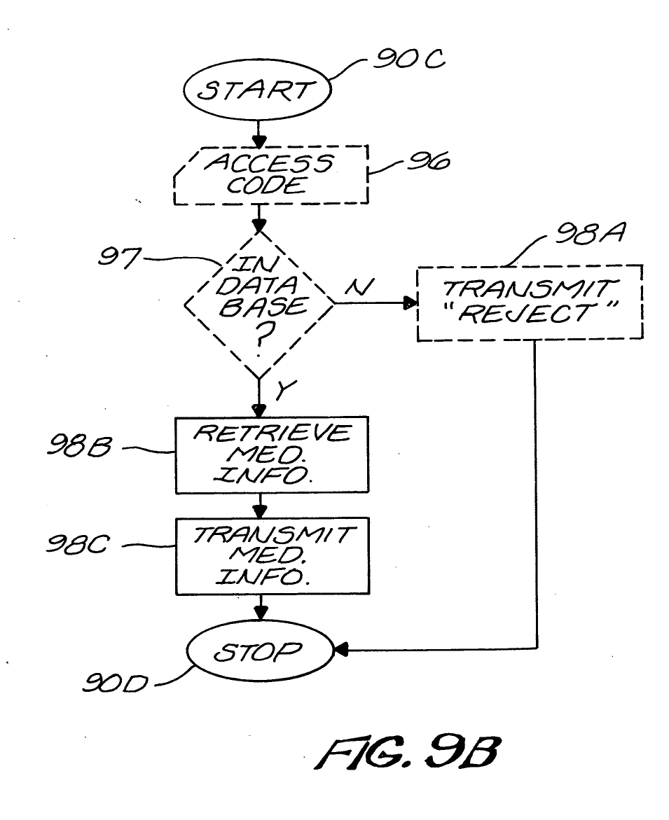

FIGS. 9A and 9B are flowcharts of the preferred operation of the cellular telephone and the remote computer's operation where the archive memory is located at the remote computer.

Referring to FIG. 9A, in some situations, the party attempting to retrieve the medical information must first identify themselves as having the authority to retrieve the medical information. In this case, once the program starts 90A, the access code is obtained from the individual using the apparatus 91A. The access code is communicated via the radio waves 91B (cellular phone or Internet). A response is received which is either “accepted” or “not accepted/rejected”92A. If accepted, the medical information is received 93 from the memory of the remote computer.

The retrieved medical information if text 82, is displayed 94 and then the program stops 90B; if not textual, then the medical information is audible and the medical information is audibly communicated 95 before the program stops 90B.

FIG. 9B illustrates the preferred operation of the remote computer of this embodiment. Once start occurs 90C, in the embodiment where an access code must be entered to obtain the information, the access code 96 is received from the apparatus, and a check is made to see if the access code (identifying the person requesting the medical information) is within the pre-set data base 97.

If the access code is within the data base, then the information is retrieved from memory 98B and transmitted to the apparatus (described in FIG. 9A) 98C before the program stops 90D.

If the access code is not appropriate, then a “not accepted/reject” is communicated 98A to the embodiment of FIG. 9A and then the program stops 90D.

It is clear that the present invention provides for an easy to use and user configurable emergency call capability.

What is claimed is:

1. A system for communicating medical information comprising:
a) a cellular telephone having a retrieval key;
b) a remote apparatus adapted to receive a message; and,
c) a remote computer having an archive memory containing medical information relative to an owner of the cell phone, whereupon, when said retrieval key is engaged,
1) said medical information is communicated to the cellular telephone, and,
2) a predefined message from said archive memory is communicated to the remote apparatus.

2. The system for communicating medical information according to claim 1, wherein said remote computer is reactive only after a correct personal access code has been received.

3. The system according to claim 2, wherein said remote apparatus is a cellular telephone.

4. The system according to claim 3, wherein said remote apparatus is a computer.

5. The system according to claim 4, wherein said archive memory includes an audio message containing said medical information.

6. A cellular telephone having:
a) an archive memory containing medical information of an owner of the cellular telephone and a pre-defined message;
b) a retrieval key; and,
c) an operating system, responsive to said retrieval key, for communicating said user-defined medical information to a user of the cellular telephone and said pre-defined message to a pre-defined remote apparatus.

7. The cellular telephone according to claim 6, further including a screen for communicating the medical information to a user.

8. The cellular telephone according to claim 6, further including an audio mechanism for communication the medical information to a user.

9. The cellular telephone according to claim 6, wherein said operating system is responsive only if a valid access code is entered by the user of the cellular telephone.

10. An emergency system comprising:
a) a cellular telephone having,
1) a screen for communicating information to a user, and,
2) a retrieval key;
b) a remote apparatus; and,
c) a remote computer in communication with the cellular telephone and having,
1) an archive memory containing medical information defined by a user of the cellular telephone, a predefined message, and a remote apparatus address, and,
2) a control system responsive to activation of the retrieval key from the cellular telephone for,
A) communicating said medical information to the cellular telephone, and,
B) communicating said predefined message to the remote apparatus; and,
wherein said cellular telephone displays said medical information on said screen.

11. The emergency system according to claim 10, wherein said cellular telephone further includes a keyboard configured to receive user-defined textual information establishing said medical information as well as the predefined message in the archive memory of said remote computer.

12. The emergency system according to claim 11, wherein the remote computer further includes a data base having authorized access codes, and wherein the control system only transmits the medical information if a user-generated access code from the cellular telephone is contained with said data base.
